(19) United States
(12) Patent Application Publication
(10) Pub. No.: US 2026/0350175 A1
(43) Pub. Date: Nov. 5, 2026

(54) COMPUTER SYSTEM FOR INTERFACING SOURCE CODE SCAN SYSTEMS ACROSS DISTRIBUTED SOURCE CONTROL REPOSITORIES

(71) Applicant: Black Duck Software, Inc., Burlington, MA (US)

(72) Inventors: Shreyas MATHIGHATTA SATYANARAYANA, Ashburn, VA (US); Vishal Gautham VENKATARAAMAN, San Jose, CA (US); Manjeet SINGH, Calgary (CA)

(21) Appl. No.: 19/194,913

(22) Filed: Apr. 30, 2025

(51) Int. Cl. G06F 21/57; G06F 21/56

(52) U.S. Cl. CPC G06F 21/577; G06F 21/563

(57) ABSTRACT

Described herein is a computer system that interfaces between a source code scan system and a source code repository. A computer system for adjusting source code includes one or more memories and one or more processors communicatively coupled to the one or more memories. The one or more processors perform an operation that includes detecting that an event occurred to a source code file in a source code repository and determining that the event caused a change to the source code file. The operation also includes translating information in the event into a format for a source code scan system, receiving, from a source code scan system and based on the translated information, an indication of a security vulnerability caused by the change to the source code file and adjusting the source code file in the source code repository based on the security vulnerability.

### TECHNICAL FIELD

The present disclosure relates to scanning source code files (e.g., to detect security vulnerabilities).

### BACKGROUND

When source code for software applications is developed, the source code may be stored in one or more source code repositories. These repositories may track and maintain different versions of the source code in different development or production branches. Source code scan systems may be used to scan the source code repositories to detect security vulnerabilities introduced by the source code in the repositories.

### SUMMARY

The present disclosure describes a computer system that interfaces between a source code scan system and a source code repository. According to an embodiment, a computer system for adjusting source code includes one or more memories and one or more processors communicatively coupled to the one or more memories. The one or more processors perform an operation that includes detecting that an event occurred to a source code file in a source code repository and determining that the event caused a change to the source code file. The operation also includes translating information in the event into a format for a source code scan system, receiving, from a source code scan system and based on the translated information, an indication of a security vulnerability caused by the change to the source code file and adjusting the source code file in the source code repository based on the security vulnerability.

The event may include the change to the source code being added (or modified) to the source code repository.

The operation may include detecting that a second event occurred that caused a change to a structure of a project comprising the source code file and adjusting a data structure representing the structure of the project to indicate the change.

Adjusting the source code file may include adding an annotation to the source code file, wherein the annotation indicates the security vulnerability.

Adjusting the source code file may include adjusting code in the source code file, wherein the adjusted code resolves the security vulnerability.

Adjusting the source code file may be based on a rate limit of the source code repository.

The operation may include determining existence of a new security vulnerability and communicating, to the source code scan system, an indication of the new security vulnerability and the source code file.

The operation may include communicating a message indicating the source code file has been adjusted. The message may include a link to the source code file.

According to another embodiment, a method includes detecting that an event occurred to a source code file in a source code repository and determining that the event caused a change to the source code file. The method also includes translating information in the event into a format for a source code scan system, receiving, from a source code scan system and based on the translated information, an indication of a security vulnerability caused by the change to the source code file and adjusting the source code file in the source code repository based on the security vulnerability.

The event may include the change to the source code being added to the source code repository.

The method may include detecting that a second event occurred that caused a change to a structure of a project comprising the source code file and adjusting a data structure representing the structure of the project to indicate the change.

Adjusting the source code file may include adding an annotation to the source code file, wherein the annotation indicates the security vulnerability.

Adjusting the source code file may include adjusting code in the source code file, wherein the adjusted code resolves the security vulnerability.

Adjusting the source code file may be based on a rate limit of the source code repository.

The method may include determining existence of a new security vulnerability and communicating, to the source code scan system, an indication of the new security vulnerability and the source code file.

The method may include communicating a message indicating the source code file has been adjusted.

The message may include a link to the source code file.

According to another embodiment, a non-transitory computer readable medium stores instructions that, when executed by one or more processors, cause the one or more processors to, individually or collectively, perform an operation that includes detecting that a change to a source code file was committed to a source code repository and communicating an indication of the change in the source code file to a source code scan system. The operation also includes receiving, from the source code scan system, an indication of a security vulnerability caused by the change to the source code file and adjusting the source code file by adding an annotation to the source code file indicating the security vulnerability caused by the change.

Adjusting the source code file may be based on a rate limit of the source code repository.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example system for determining a security vulnerability.

FIG. 2 illustrates an example operation for analyzing an event performed by the system of FIG. 1.

FIG. 3 illustrates an example operation for analyzing an event performed by the system of FIG. 1.

FIG. 4 illustrates an example operation for adjusting a source code file performed by the system of FIG. 1.

FIG. 5 illustrates an example operation for adjusting a source code file performed by the system of FIG. 1.

FIG. 6 illustrates an example operation for adjusting a source code file performed by the system of FIG. 1.

FIG. 7 illustrates an example operation for triggering a scan performed by the system of FIG. 1.

FIG. 8 is a flowchart of an example method for adjusting a source code file performed by the system of FIG. 1.

FIG. 9 depicts a diagram of an example computer system in which embodiments of the present disclosure may operate.

### DETAILED DESCRIPTION

Source code scan systems may be used to scan source code files in a source code repository (which may also be referred to as source control repositories) to detect security vulnerabilities in the source code files. In existing systems, users instruct a source code scan system to scan source code files in a repository to detect security vulnerabilities. The users may decide when it is appropriate to scan and how to set the parameters of the scan (e.g., which source code files are scanned, what type of scan to run, etc.). Different users, however, may make these determinations differently, which results in the source code scan system being used inconsistently. As a result, some security vulnerabilities may remain undetected.

Additionally, different source code repositories are configured and used differently. As a result, the source code scan system may need to be configured differently to scan different repositories. This complexity may discourage users from using the source code scan system correctly or using the source code scan system at all, which results in some security vulnerabilities remaining undetected.

Aspects of the present disclosure relate to a computer system that interfaces between a source code scan system and a source code repository. Generally, the computer system detects when events occur that change a source code file in the repository. The computer system may then indicate to a source code scan system that the source code file changed, and the source code scan system may automatically determine which source code files to scan and which scans to perform. The source code scan system may then communicate any determined security vulnerabilities to the computer system. The computer system may then determine which portions of the source code file caused the security vulnerabilities. The computer system may then adjust the source code file to indicate the portions of the source code file and the security vulnerabilities. For example, the computer system may add annotations to the source code file indicating the portions and the security vulnerabilities. The computer system may then commit the adjustments to the source code file to the repository.

In certain embodiments, the computer system provides several technical advantages. For example, the computer system may allow the source code scan system to interface with many different types of source code repositories. As another example, the computer system may automatically trigger the source code scan system to scan, rather than relying on human judgment to initiate scans. As another example, the computer system may adjust source code files based on determined security vulnerabilities.

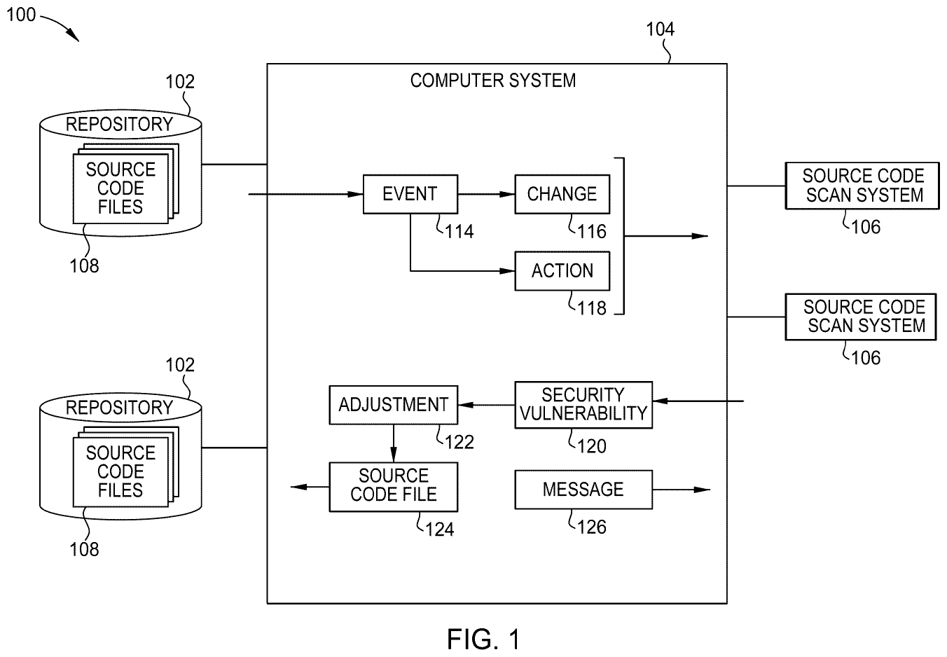

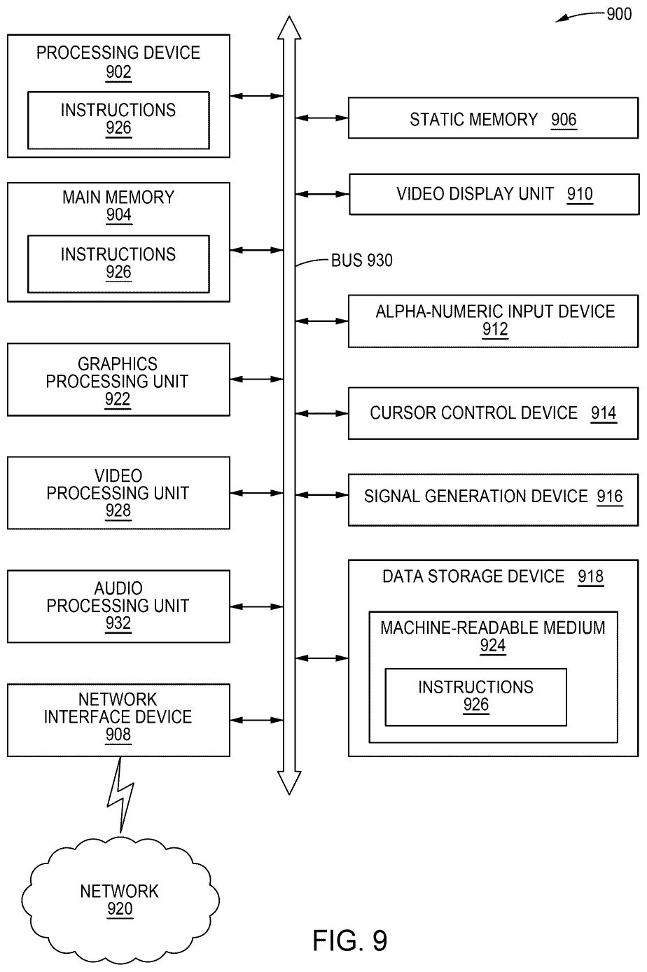

FIG. 1 illustrates an example system 100 for determining a security vulnerability. As seen in FIG. 1, the system 100 includes one or more repositories 102 (e.g., databases), a computer system 104 (which may be the computer system 900 shown in FIG. 9), and one or more source code scan systems 106. Generally, the computer system 104 detects events at the repository 102 that causes changes to source code files in the repository 102. The computer system 104 indicates the events and the changes to the source code scan system 106, and the source code scan system 106 determines which source code files to scan based on the events and changes. The source code scan system 106 then indicates to the computer system 104 the security vulnerabilities that the source code scan system 106 detected by scanning the source code files. The computer system 104 then adjusts the source code files in the repository 102 based on the detected security vulnerabilities.

The repositories 102 in the system 100 may be databases or storage systems that store one or more source code files 108. Each source code file 108 may include source code for one or more software applications. Each repository 102 may be a different type of repository and may store and maintain source code files 108 differently. Each repository 102 may use different application programming interface calls to perform different functions with respect to the source code files 108 in the repository 102. For example, each repository 102 may use a different function call (e.g., commit, check-in, merge, etc.) to propagate a change to a source code file 108 into the repository 102. As another example, each repository 102 may use a different function call (e.g., retrieve, get, check-out, etc.) to download and lock a source code file 108 in the repository 102.

As discussed above, existing systems may place the burden on the user or developer to determine when to use the source code scan system to scan the source code files and what type of scan to perform (e.g., full scan, quick scan, etc.). Different users and developers may make this determination differently, which leads to inconsistent use of the source code scan systems 106 and which may lead to some security vulnerabilities going undetected. Additionally, the users and developers may be responsible for setting up the source code scan system 106 to interface with the repository, which may store and maintain the software code files differently from other types of repositories. The computer system 104 serves as an interface between the repositories 102 and the source code scan systems 106. Generally, the computer system 104 may detect and determine when events occur at the repository 102 that change one or more source code files 108. The computer system 104 may translate the event and change the information in the event into a format that the source code scan system 106 uses. The computer system 104 then scans the changed source code files 108 to detect security vulnerabilities, and the computer system 104 adjusts the source code files 108 based on the security vulnerabilities. In this manner, the computer system 104 interfaces between the repositories 102 and the source code scan system 106. Additionally, the computer system 104 may flag and/or resolve security vulnerabilities detected by the source code scan systems 106.

The source code scan system 106 receives information from the computer system 104 indicating the event at the repository 102 and the change to the source code file 108. The source code scan system 106 then determines, based on the information from the computer system 104, the source code files 108 to scan and the types of scans to perform. For example, the source code scan system 106 may determine that different source code files 108 should be scanned for different types of changes to the source code files 108 and for different types of source code files 108 (e.g., the functionality implemented by the source code files 108). As another example, the source code scan system 106 may determine different source code files 108 should be scanned or different types of scans (e.g., full scans, partial scans, quick scans, etc.) should be performed depending on the branch to which the changed source code files 108 belong (e.g., development branch vs. production branch, main branch vs. minor branch, etc.). The source code scan system 106 then scans the source code files 108 to detect security vulnerabilities exposed by the source code files 108. The source code scan system 106 may report the security vulnerabilities to the computer system 104.

The computer system 104 receives the security vulnerabilities from the source code scan system 106. The computer system 104 may then adjust the source code files 108 in the repository 102 to indicate the security vulnerabilities. For example, the computer system 104 may add to the source code files 108 annotations that indicate the security vulnerabilities. The annotations may be positioned by the portions of the source code that exposed the security vulnerabilities to indicate the portions of the source code that should be changed. In some embodiments, the computer system 104 may also change the source code to fix the security vulnerabilities. The computer system 104 may propagate or store the changed source code files 108 into the repository 102 to be viewed by a user or developer.

In an example operation, the computer system 104 begins by receiving or detecting an event 114 at a repository 102. For example, the computer system 104 may implement listeners or adapters that monitor the activity at the repository 102. When a function call occurs at the repository 102 (e.g., retrieve a source code file 108, commit a source code file 108, create or modify a project, create or modify a branch of a project, etc.), the computer system 104 detects the event 114. The event 114 may indicate the function call that was made at the repository 102.

The computer system 104 analyzes the event 114 to determine a change 116 that was made to a source code file 108 in the repository 102 as a result of the function call. For example, if the function call is a commit or check-in of the source code file 108 with the change 116, then the computer system 104 may determine that the event 114 caused the change 116 to the source code file 108. The computer system 104 may also analyze the event 114 to determine an action 118. The action 118 may indicate the function call that was made at the repository 102. Because different types of repositories 102 may use different function calls to perform the same action 118 (e.g., retrieve, commit, etc.), the computer system 104 may use a dictionary to translate the function call indicated by the event 114 into the action 118 that is understandable by the source code scan system 106. The computer system 104 then communicates the change 116 and the action 118 to the source code scan system 106.

The source code scan system 106 uses the information in the change 116 and the action 118 to determine the source code files 108 that should be scanned. The source code scan system 106 may also determine the types of scans to perform. The source code scan system 106 then scans the source code files 108 to detect security vulnerabilities exposed by the change 116 to the source code file 108. The source code scan system 106 may report a detected security vulnerability 120 to the computer system 104.

The computer system 104 receives the security vulnerability 120 from the source code scan system 106. The computer system 104 analyzes the security vulnerability 120 to determine an adjustment 122 that may be made to the source code file 108. The computer system 104 may make the adjustment 122 to the source code file 108 to produce a source code file 124. The computer system 104 then propagates the source code file 124 that includes the adjustment 122 to the repository 102 (which may overwrite the source code file 108 in the repository 102).

The adjustment 122 may include any change to the source code file 108. For example, the adjustment 122 may include adding an annotation (e.g., a comment) to the source code file 108. The annotation may indicate the security vulnerability 120. Additionally, the computer system 104 may add the annotation by or within the source code in the source code file 108 that caused the security vulnerability 120. As another example, the adjustment 122 may include a change to the source code in the source code file 108. The change may be made to the source code that caused the security vulnerability 120, and the change may fix or resolve the security vulnerability 120.

In some embodiments, the computer system 104 generates and communicates a message 126 to a user or developer indicating the security vulnerability 120, the source code file 108, the source code file 124, and/or the repository 102. For example, the message 126 may indicate the security vulnerability 120 that was caused by the source code file 108, and the message 126 may include a link to the source code file 124 in the repository 102. The user or developer may interact with the link to view the source code file 124 and the adjustment 122.

The computer system 104 may interface between any number of repositories 102 of any number of types and any number of source code scan systems 106. For example, the computer system 104 may be provisioned on the cloud and may interface between repositories 102 and source code scan systems 106 of multiple users and/or developers. The computer system 104 may detect events on any type of repository 102 and translate the information in those events to be useable by the source code scan system 106.

In some embodiments, the computer system 104 maintains credentials (e.g., authentication and authorization credentials) that are used to gain access to the repository 102. The computer system 104 may use these credentials to be permitted to listen for events at the repository 102, retrieve or download source code files 108 from the repository 102, upload source code files 124 to the repository 102, etc. The repository 102 may use these credentials to track or log the actions of the computer system 104. For example, the computer system 104 may implement signature verification using cryptographic keys to ensure payload authenticity and origin validation. The computer system may use system classification identifiers, repository infrastructure types, and/or implementation specific metadata to identify various platforms.

In certain embodiments, the computer system 104 may also track metrics or statistics about the system 100. For example, the computer system 104 may track the number and/or timing of security vulnerabilities detected, the number and/or timing of source code files changed by the computer system 104, etc. The computer system may report these metrics and statistics in a report or dashboard, which may help scale and schedule tasks in the system 100.

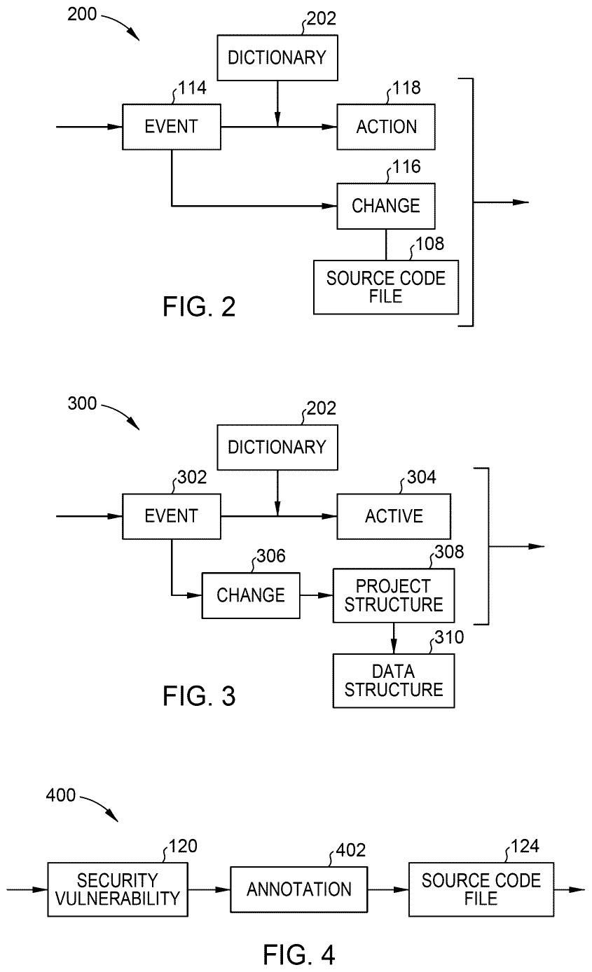

FIG. 2 illustrates an example operation 200 for analyzing an event performed by the system 100 of FIG. 1. Generally, a computer system (e.g., the computer system 900 shown in FIG. 9) performs the operation 200. By performing the operation 200, the computer system detects an event at a repository and prepares the information in the event for a source code scan system.

The computer system begins by detecting the event 114 at the repository. The event 114 may involve a function call being performed at the repository. For example, the event 114 may involve a changed source code file being committed to the repository. Different repositories may use different functions or application programming interface calls to perform the same function. As a result, the event 114 may include different information for different repositories.

The computer system may implement a dictionary 202 that includes translations for the information in the event 114. For example, the computer system may use the dictionary 202 to translate the information in the event 114 into terms that a source code scan system may understand. As seen in FIG. 2, the computer system determines the action 118 from the event 114 using the dictionary 202. In this example, the dictionary 202 may include a translation from the function call indicated by the event 114 to the action 118. The action 118 may be specified using terms that the source code scan system would understand. As an example, if the event 114 indicates that a check-in function was performed at the repository to commit the changed source code file to the repository, the dictionary 202 may indicate that the check-in function performs a commit action. In response, the computer system may use the dictionary 202 to indicate that the action 118 is commit (e.g., rather than check-in, which the source code scan system may not understand). In this manner, the computer system uses the dictionary 202 to standardize the format of the information in the event 114 for the source code scan system.

The computer system may also analyze the event 114 to determine the change 116 to the source code file 108. For example, the event 114 may indicate the portions of the source code file 108 that have been changed and what those changes were.

The computer system may then communicate the action 118 and the change 116 (and/or the source code file 108) to a source code scan system so that the source code scan system may determine what source code files 108 to scan and what types of scans should be performed. The source code scan system may then scan the source code files 108. The scans may reveal that a change to the source code file exposed or created a security vulnerability.

FIG. 3 illustrates an example operation 300 for analyzing an event performed by the system 100 of FIG. 1. Generally, a computer system (e.g., the computer system 900 shown in FIG. 9) may perform the operation 300. By performing the operation 300, the computer system tracks the structure of a project that includes one more source code files.

The computer system begins by detecting that an event 302 occurred at the repository. The event 302 may involve a function call being performed at the repository. For example, the event 302 may involve a project or branch of a project being created or changed (e.g., adding a new source code file to a branch, creating a new development branch or project, moving a branch from a development branch to a production branch, etc.). The computer system may use the dictionary 202 to translate the information in the event 302 into the action 304 that is understood by the source code scan system. The computer system may also determine a change 306 indicated by the event 302. For example, the change 306 may indicate a change to a project structure 308 in the repository. The change 306 may include a new project being created, a new branch being created in a project, deletion of a branch in a project, adding or moving a source code file to a branch, etc.

The computer system may maintain a data structure 310 that represents the project structure 308 in the repository. For example, the data structure 310 may include portions that represent the branches of the project. The computer system may update the data structure 310 to account for the change 306 to the project structure 308. As an example, if the change 306 causes a new branch to be created, the computer system may update the data structure 310 so that the data structure 310 includes a portion that represents the new branch. As another example, if the change 306 causes a branch to grow larger (e.g., because source code files were added to the branch), the computer system may adjust the portion of the data structure 310 to represent a larger branch.

The computer system may communicate the data structure 310 to the source code scan system along with other information from the event 302 (e.g., the action that was performed and the change to a source code file). The source code scan system may determine from the data structure 310 what source code files should be scanned. For example, if the data structure 310 indicates that there was a change to a source code file in a large and important branch of the project, the source code scan system may determine that a large section of the project (e.g., a large portion of the repository) should be scanned. If the data structure 310 indicates that there was a change to a source code file in a remote and small branch of the project, the source code scan system may determine that a small portion of the project (e.g., a small portion of the repository) should be scanned.

FIG. 4 illustrates an example operation 400 for adjusting a source code file performed by the system 100 of FIG. 1. Generally, a computer system (e.g., the computer system 900 shown in FIG. 9) performs the operation 400. By performing the operation 400, the computer system adjusts a source code file to indicate s security vulnerability.

The computer system begins by receiving the security vulnerability 120 from the source code scan system. The source code scan system may have detected the security vulnerability 120 when scanning a source code file. The source code scan system may also indicate to the computer system the portion of the source code file that caused, introduced, included, or exposed the security vulnerability 120.

The computer system generates an annotation 402 that may include a message indicating the security vulnerability 120. For example, the annotation 402 may be a comment that identifies and/or describes the security vulnerability 120. The computer system may then add the annotation 402 to the source code file to produce the source code file 124. In some instances, the computer system may add the annotation 402 in or by the portion of the source code that caused, introduced, included, or exposed the security vulnerability 120. In this manner, the computer system uses the annotation 402 to mark the source code for a user or developer. When the user or developer views the source code file 124, the annotation 402 may indicate to the user or developer the security vulnerability 120 and the portion of the source code that should be changed to resolve or fix the security vulnerability 120.

The computer system may then propagate the source code file 124 to the repository. For example, the computer system may commit or check-in the source code file 124 to the repository, which may overwrite the original source code file that had been downloaded from the repository.

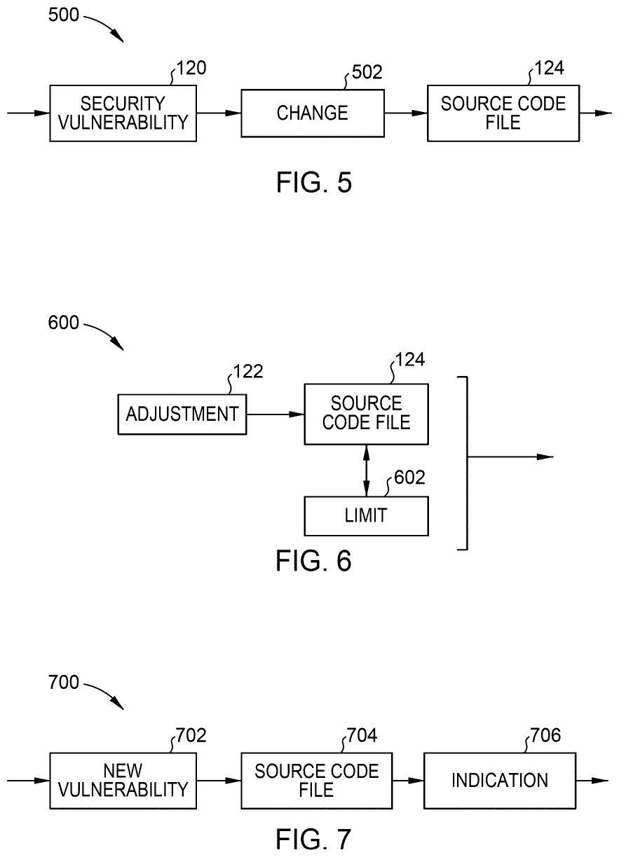

FIG. 5 illustrates an example operation 500 for adjusting a source code file performed by the system 100 of FIG. 1. Generally, a computer system (e.g., the computer system 900 shown in FIG. 9) performs the operation 500. By performing the operation 500, the computer system determines a change to source code in the source code file to resolve a security vulnerability.

The computer system may receive the security vulnerability 120 from the source code scan system. The source code scan system may also indicate the portions of source code that caused or included the security vulnerability 120. In some instances, due to the nature of the security vulnerability 120, the computer system may automatically determine a change 502 to the source code that would resolve or fix the security vulnerability 120. For example, the computer system may refer to a ruleset or use artificial intelligence to generate the change 502 based on the source code and the security vulnerability 120. The computer system may then make the change 502 to the source code file to produce the source code file 124. The computer system may add comments or annotations to the source code file 124 to indicate the security vulnerability and the change 502 made to the source code.

The computer system may then propagate the source code file 124 to the repository. For example, the computer system may commit or check-in the source code file 124 to the repository, which may overwrite the original source code file that had been downloaded from the repository. In this manner, the computer system automatically resolves or fixes the security vulnerability 120 detected by the source code scan system.

FIG. 6 illustrates an example operation 600 for adjusting a source code file performed by the system 100 of FIG. 1. Generally, a computer system (e.g., the computer system 900 shown in FIG. 9) performs the operation 600. By performing the operation 600, the computer system adjusts a source code file based on limits of the repository.

The computer system may begin by determining the adjustment 122 (e.g., an annotation, a change to source code, etc.). The computer system may then make the adjustment 122 to a source code file to produce the source code file 124. The computer system may then propagate the source code file 124 to the repository. In some instances, the repository may place a limit 602 on the number of operations (e.g., commit or check-in operations) that the repository will handle in a period of time (e.g., a rate limit). If propagating the source code file 124 to the repository would violate the limit 602, then the computer system may make changes to accommodate the limit 602.

For example, the computer system may stagger the upload of the source code file 124 and other source code files to the repository over a longer period of time (e.g., using a queue). In this manner, the computer system may reduce the number of operations directed at the repository over a period of time. As another example, the computer system may delay the upload of the source code file 124 and other source code files to the repository. In this manner, the computer system may wait for the limit 602 to be refreshed before uploading the source code file 124. When the computer system detects that the computer system may be violating the limit 602, the computer system may implement a retry mechanism with exponential backoff to allow time for the limit 602 to refresh. The duration of the backoff period may be adjusted.

The repository may implement any type of limit 602. For example, the limit 602 may limit the number of operations over a period of time. As another example, the limit 602 may limit the number of concurrent operations in the repository. As another example, the limit 602 may limit the upload size to the repository. The computer system may automatically and dynamically adjust the propagation of source code files to the repository to account for any limit 602 that the repository places on uploads.

FIG. 7 illustrates an example operation 700 for triggering a scan performed by the system of FIG. 1. Generally, a computer system (e.g., the computer system 900 shown in FIG. 9) performs the operation 700. By performing the operation 700, the computer system detects a new security vulnerability and triggers a security scan from the source code scan system.

The computer system begins by detect a new vulnerability 702. For example, the computer system may scan or crawl the Internet, technology sites, cybersecurity newsletters, etc. to detect that a new vulnerability 702 has been discovered. In response, the computer system may determine whether the new vulnerability 702 affects any of the source code files in a repository. For example, based on the information about the new vulnerability 702, the computer system may determine that the new vulnerability 702 impacts a source code file 704 in the repository because the source code file 704 includes source code that causes or exposes the new vulnerability 702.

The computer system generates an indication 706 that indicates the source code file 704 is affected by the new vulnerability 702. The indication 706 may also indicate the new vulnerability 702. The computer system may communicate the indication 706 to the source code scan system, which may trigger the source code scan system to scan the source code file 704 and other portions of the repository. After scanning, the source code scan system may report to the computer system the security vulnerabilities detected by the source code scan system. In this manner, the computer system may trigger the source code scan system to scan without a change to a source code file being made prior to the scan.

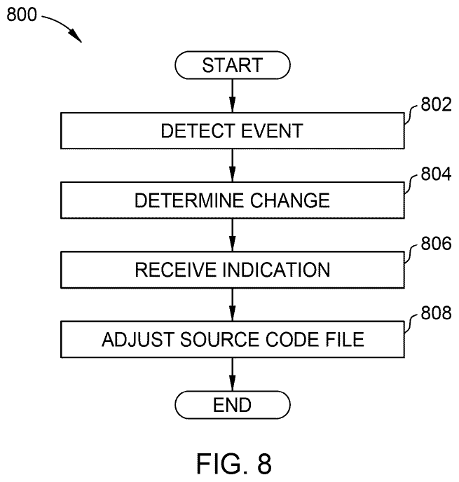

FIG. 8 is a flowchart of an example method 800 for adjusting a source code file performed by the system 100 of FIG. 1. In particular embodiments, a computer system (e.g., the computer system 900 shown in FIG. 9) performs the method 800. By performing the method 800, the computer system adjusts a source code file based on a security vulnerability detected by a source code scan system.

At 802, the computer system detects that an event occurred at a repository. The computer system may implement listeners or adapters that monitor the activity at the repository. When a function is called at the repository, the computer system may determine that an event is occurring at the repository. As an example, the function may commit a change to a source code file in the repository. The computer system may indicate in the event the action that was performed at the repository and the change to the source code file.

At 804, the computer system determines that the event caused a change to the source code file. For example, the event may indicate the portion of the source code file that had been changed as a result of the function call. The computer system may then communicate the action and/or the change to a source code scan system. The source code scan system may determine the scans to be performed against the source code file. By scanning the source code file, the source code scan system may detect a security vulnerability caused or exposed by the source code file.

At 806, the computer system receives an indication from the source code scan system of the detected security vulnerability. The indication may also indicate a portion of the source code file that caused or exposed the security vulnerability.

At 808, the computer system adjusts the source code file based on the indication from the source code scan system. For example, the computer system may add an annotation to the source code file that indicates the security vulnerability. The computer system may position the annotation by or near the portion of the source code file that caused or exposed the security vulnerability. As a result, the annotation may further mark or flag the code that caused or exposed the security vulnerability. In some embodiments, the computer system may automatically change the source code in the source code file to fix or resolve the security vulnerability as part of the adjustment to the source code file. After adjusting the source code file, the computer system may propagate the adjusted source code file to the repository, which may overwrite the original source code file in the repository. A user or developer may then view the source code file in the repository to understand the detected security vulnerability.

FIG. 9 illustrates an example machine of a computer system 900 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM), a static memory 906 (e.g., flash memory, static random access memory (SRAM), etc.), and a data storage device 918, which communicate with each other via a bus 930.

Processing device 902 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 may be configured to execute instructions 926 for performing the operations and steps described herein.

The computer system 900 may further include a network interface device 908 to communicate over the network 920. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable storage medium 924 (also known as a non-transitory computer-readable medium) on which is stored one or more sets of instructions 926 or software embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media.

In some implementations, the instructions 926 include instructions to implement functionality corresponding to the present disclosure. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 902 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A computer system for adjusting source code, the computer system comprising:
one or more memories; and
one or more processors communicatively coupled to the one or more memories, the one or more processors configured to, individually or collectively, perform an operation comprising:
detecting that an event occurred to a source code file in a source code repository;
determining that the event caused a change to the source code file;
translating information in the event into a format for a source code scan system;
receiving, from a source code scan system and based on the translated information, an indication of a security vulnerability caused by the change to the source code file; and
adjusting the source code file in the source code repository based on the security vulnerability.

2. The computer system of claim 1, wherein the event comprises the change to the source code being added to the source code repository.

3. The computer system of claim 1, wherein the operation further comprises:
detecting that a second event occurred that caused a change to a structure of a project comprising the source code file; and
adjusting a data structure representing the structure of the project to indicate the change.

4. The computer system of claim 1, wherein adjusting the source code file comprises adding an annotation to the source code file, wherein the annotation indicates the security vulnerability.

5. The computer system of claim 1, wherein adjusting the source code file comprises adjusting code in the source code file, wherein the adjusted code resolves the security vulnerability.

6. The computer system of claim 1, wherein adjusting the source code file is based on a rate limit of the source code repository.

7. The computer system of claim 1, wherein the operation further comprises:
determining existence of a new security vulnerability; and
communicating, to the source code scan system, an indication of the new security vulnerability and the source code file.

8. The computer system of claim 1, wherein the operation further comprises communicating a message indicating the source code file has been adjusted.

9. The computer system of claim 8, wherein the message comprises a link to the source code file.

10. A method comprising:
detecting that an event occurred to a source code file in a source code repository;
determining that the event caused a change to the source code file;
translating information in the event into a format for a source code scan system;
receiving, from a source code scan system and based on the translated information, an indication of a security vulnerability caused by the change to the source code file; and
adjusting the source code file in the source code repository based on the security vulnerability.

11. The method of claim 10, wherein the event comprises the change to the source code being added to the source code repository.

12. The method of claim 10, further comprising:
detecting that a second event occurred that caused a change to a structure of a project comprising the source code file; and
adjusting a data structure representing the structure of the project to indicate the change.

13. The method of claim 10, wherein adjusting the source code file comprises adding an annotation to the source code file, wherein the annotation indicates the security vulnerability.

14. The method of claim 10, wherein adjusting the source code file comprises adjusting code in the source code file, wherein the adjusted code resolves the security vulnerability.

15. The method of claim 10, wherein adjusting the source code file is based on a rate limit of the source code repository.

16. The method of claim 10, further comprising:
determining existence of a new security vulnerability; and
communicating, to the source code scan system, an indication of the new security vulnerability and the source code file.

17. The method of claim 10, further comprising communicating a message indicating the source code file has been adjusted.

18. The method of claim 17, wherein the message comprises a link to the source code file.

19. A non-transitory computer readable medium storing instructions that, when executed by one or more processors, cause the one or more processors to, individually or collectively, perform an operation comprising:
detecting that a change to a source code file was committed to a source code repository;
communicating an indication of the change in the source code file to a source code scan system;
receiving, from the source code scan system, an indication of a security vulnerability caused by the change to the source code file; and
adjusting the source code file by adding an annotation to the source code file indicating the security vulnerability caused by the change.

20. The medium of claim 19, wherein adjusting the source code file is based on a rate limit of the source code repository.
